(19) United States
(12) Patent Application Publication
(10) Pub. No.: US 2025/0141264 A1
(43) Pub. Date: May 1, 2025

(54) POWER RECEIVING APPARATUS

(71) Applicant: Daifuku Co., Ltd., Osaka (JP)

(72) Inventor: Tomohiro KITAMURA, Shiga (JP)

(21) Appl. No.: 18/925,741

(22) Filed: Oct. 24, 2024

(30) Foreign Application Priority Data
Oct. 27, 2023 (JP) 2023-184491

(51) Int. Cl. H02J 50/00; B60L 13/00; H02J 50/10

(52) U.S. Cl. CPC H02J 50/005; H02J 50/10; B60L 13/006; B60L 2200/26

(57) ABSTRACT

A power receiving apparatus receives power from an electric cable through which an AC current flows in a noncontact manner, and supplies the power to a target equipment. The power receiving apparatus includes: a coupler provided in a state where a position thereof relative to the electric cable is fixed. The coupler includes a magnetic core disposed to surround the electric cable, and a coil wound around the magnetic core. The magnetic core includes first and second core portions that are divided from each other by a core division plane. In the second core portion, a facing surface is formed in a flat shape to be disposed along the core division plane while facing the first core portion, and a nonmagnetic body is disposed along the facing surface to cover the facing surface, and sandwiched between the first and second core portions.

### CROSS-REFERENCE TO RELATED APPLICATIONS

This application is based on and claims priority from Japanese Patent Application No. 2023-184491, filed on Oct. 27, 2023, with the Japan Patent Office, the disclosure of which is incorporated herein in its entirety by reference.

### TECHNICAL FIELD

The present disclosure relates to a power receiving apparatus.

### BACKGROUND

Japanese Patent Laid-Open Publication No. 2006-141115 discloses a power supplying apparatus provided with a noncontact power supplying transformer (e.g., a coupler unit) disposed at a power supplying line. The power supplying transformer includes a magnetic core and a pickup coil wound around the magnetic core. The magnetic core is disposed to surround the power supplying line. The magnetic flux generated by the current flowing in the power supplying line passes through the magnetic core, so that power is supplied to the pickup coil in the noncontact manner.

### SUMMARY

An embodiment of the present disclosure provides a power receiving apparatus for receiving power from an electric cable through which an AC current flows, in a noncontact manner, and supplying the power to a target equipment. The power receiving apparatus includes: a coupler provided in a state where a position thereof relative to the electric cable is fixed. The coupler includes a magnetic core disposed to surround the electric cable, and a coil wound around the magnetic core. The magnetic core includes a first core portion and a second core portion that are divided from each other by a core division plane. In the second core portion, a facing surface is formed in a flat shape to be disposed along the core division plane while facing the first core portion. A nonmagnetic body made of a nonmagnetic material is disposed along the facing surface to cover the facing surface, and sandwiched between the first core portion and the second core portion.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic configuration view of a transport facility.

FIG. 2 is a front view of a moving body.

FIG. 3 is a front view schematically illustrating a coupler unit.

FIG. 4 is a cross-sectional view along IV-IV in FIG. 3.

FIG. 5 is a cross-sectional view of a power receiving apparatus.

FIG. 6 is a circuit diagram of a power conversion unit.

FIG. 7 is an enlarged view of a main part of a transport facility according to another embodiment.

### DETAILED DESCRIPTION

In the following detailed description, reference is made to the accompanying drawings which form a part hereof. The illustrative embodiments described in the detailed description, drawings, and claims are not meant to be limiting. Other embodiments may be utilized, and other changes may be made without departing from the spirit or scope of the subject matter presented herein.

In the power receiving apparatus described above, in order to extract a larger power from the power supplying line, it is desirable to collect more magnetic flux by the magnetic core, and thus, enhance the induced electromotive force. As a result, meanwhile, when the magnetic flux density increases, the magnetic core may easily saturate magnetically, and therefore, it may become difficult to extract the power stably. When the magnetic core magnetically saturates, excessive current may flow in the coil, which may damage the power receiving apparatus itself. Thus, it is considered to avoid the magnetic saturation by making a big magnetic core or using a magnetic core with a superior magnetic performance, which, however, causes problems such as increase in size of the power receiving apparatus and manufacturing costs.

Therefore, in the power receiving apparatus that receives a power from an electric cable in a noncontact manner, it is necessary to provide a technology for stably supplying a power to a target equipment.

The present disclosure provides a power receiving apparatus for receiving power from an electric cable through which an AC current flows, in a noncontact manner, and supplying the power to a target equipment. The power receiving apparatus includes: a coupler provided in a state where a position thereof relative to the electric cable is fixed. The coupler includes a magnetic core disposed to surround the electric cable, and a coil wound around the magnetic core. The magnetic core includes a first core portion and a second core portion that are divided from each other by a core division plane. In the second core portion, a facing surface is formed in a flat shape to be disposed along the core division plane while facing the first core portion. A nonmagnetic body made of a nonmagnetic material is disposed along the facing surface to cover the facing surface, and sandwiched between the first core portion and the second core portion.

According to the configuration above, the magnetic core is divided into the first core portion and the second core portion, and the nonmagnetic body is disposed to cover the facing surface of the second core portion and sandwiched between the first core portion and the second core portion, so that the first core portion and the second core portion are not continuously connected. As a result, the magnetic resistance in the magnetic core may be increased, which may make it difficult for the magnetic core to saturate magnetically. Therefore, it is possible to suppress, for example, the occurrence of a situation that the inductance of the coil drops rapidly due to the magnetic saturation of the magnetic body, and thus, an overcurrent flows in the coil, so that the current drawn from the coil may easily be stabilized.

Further, according to the present configuration, the magnitude of magnetic resistance (magnitude of magnetic permeability) of the magnetic core may be adjusted by adjusting the thickness of the nonmagnetic material in advance, so that the non-uniformity of the characteristics of the power receiving apparatus may easily be reduced.

Further, according to the present configuration, the facing surface of the second core portion is formed in a flat shape, and the nonmagnetic body made of a nonmagnetic material is disposed along the facing surface to cover the facing surface, so that the shape of the second core portion may easily be simplified, and the shape of the nonmagnetic body may easily be made flat. Therefore, the shape or structure of the nonmagnetic body may easily be simplified, and the work for attaching the nonmagnetic body may easily be simplified.

According to the present configuration, a power may be stably supplied to the target equipment.

Additional features and advantages of the power receiving apparatus are clarified from illustrative and non-limiting embodiments, which are described herein below with reference to the drawings.

Hereinafter, an example in which a power receiving apparatus is applied to a transport facility is described with reference to the drawings.

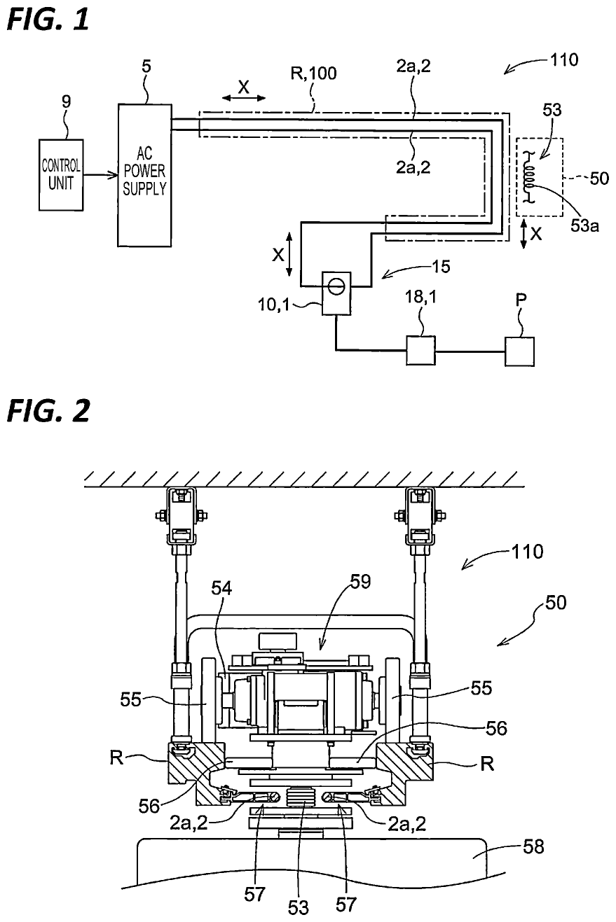

As illustrated in FIGS. 1 and 2, a transport facility 110 includes a travel rail R disposed along a travel path 100, a moving body 50 that moves by being guided by the travel rail R, an electric cable 2 that supplies an electric power for driving to the moving body 50 in a non-contact manner, an equipment P, and a control unit 9 that controls the entire transport facility 110. The moving body 50 moves along the travel path 100 by being guided by the travel rail R. The electric cable 2 is disposed along the travel path 100. In the present example, the moving body 50 moves along the travel path 100 to transport articles. The equipment P includes various devices (e.g., peripheral devices) installed in the transport facility 110.

As illustrated in FIG. 2, the travel rail R is disposed along the ceiling. Specifically, a pair of travel rails R is supported by being suspended from the ceiling. Thus, the moving body 50 is configured to move along the travel path 100 formed along the ceiling, while being guided by the pair of travel rails R. In the present example, the moving body 50 is an overhead transport vehicle. The articles to be transported by the moving body 50 may be, for example, front opening unified pods (FOUPs) or front opening shipping boxes (FOSBs), but are not limited thereto.

The moving body 50 includes a traveling portion 59 that travels on the travel rail R, a body portion 58 disposed below the travel rail R and supported by being suspended from the traveling portion 59, and a power receiving unit 53 that receives a power from the electric cable 2 in a noncontact manner. The body portion 58 includes an accommodation unit (not illustrated) that accommodates an article to be transported, and an article support unit (not illustrated) that holds the article and moves the article up and down with respect to the accommodation unit. When traveling along the travel rail R, the moving body 50 accommodates and holds an article in the accommodating unit. When transferring an article to a transfer target location in the stop state, the moving body 50 moves the article up and down with respect to the accommodation unit, to perform a transfer operation with respect to the transfer target location below the accommodation unit. The transfer target location may be, for example, a port of a processing apparatus that performs a predetermined processing on semiconductor substrates (placement unit for transferring an article to the processing apparatus) or a storage shelve for storing articles.

The traveling portion 59 is provided with traveling wheels 55 (a plurality of traveling wheels 55 in the present example) that rolls on the top surface of the travel rail R. Further, the traveling portion 59 is provided with a traveling motor 54 that rotates and drives at least one of the plurality of traveling wheels 55. As a result of the rotation driving by the traveling motor 54, the moving body 50 may have the propulsive force to travel on the travel rail R. Further, the traveling portion 59 is provided with a pair of guide wheels 56 that rotates freely around an axis along the vertical direction. Each of the pair of guide wheels 56 rolls on the inner surface of the corresponding travel rail R.

The power supplied to the various actuators (including the traveling motor 54) provided in the moving body 50 is supplied from the electric cable 2 through the power receiving unit 53. As illustrated in FIG. 1, the electric cable 2 is connected to an AC power supply 5 provided in the transport facility 110. Further, as illustrated in FIG. 2, the electric cable 2 is supported by each travel rail R. In the illustrated example, the electric cable 2 includes a pair of power feeding lines 2a. Here, the pair of power feeding lines 2a are formed in the manner that a single electric cable 2 is disposed by being folded back (FIG. 1). In the descriptions herein below, the folded portion of the electric cable 2 is referred to as a folded portion 15. In the present example, the power feeding lines 2a are arranged on the travel rails R, respectively. Specifically, the pair of power feeding lines 2a are supported by support members 57, respectively, fixed to the travel rail R, and disposed to sandwich the power receiving unit 53 of the moving body 50 therebetween. When a radio-frequency current flows in the power feeding lines 2a, the power receiving unit 53 generates a magnetic field around the power feeding lines 2a. The power receiving unit 53 is provided with, for example, a pickup coil 53a or a magnetic core, and the pickup coil 53a is induced by the electromagnetic induction from the magnetic field. The induced AC current is converted into a DC current by a rectifier circuit such as a full-wave rectifier circuit or a power receiving circuit (not illustrated) equipped with, for example, a smoothing capacitor, and supplied to an actuator or the drive circuit.

In the descriptions herein, a so-called overhead transport vehicle is described as an example of the moving body 50. However, the moving body 50 may be an article transport vehicle traveling on the ground (including an article transport vehicle traveling along a storage unit of each tier in a storage rack including vertically arranged multiple-tier storage units), or may be, for example, a traveling cart of a stacker crane. The moving body 50 may be provided in any form as long as the moving body 50 operates by being supplied with the electric power from the electric cable 2. Further, the moving body 50 is not limited to an article transport vehicle.

In the descriptions herein below, the direction along the electric cable 2 (power feeding lines 2a) is referred to as an electric cable direction X, a specific direction perpendicular to the electric cable direction X is referred to as a width direction Y, and the direction perpendicular to both the electric cable direction X and the width direction Y is referred to as a vertical direction Z. Further, one side of the vertical direction Z is referred to as a first side of vertical direction Z1, and the opposite side thereto is referred to as a second side of vertical direction Z2.

As described above, the moving body 50 is supplied with the power from the power feeding lines 2a disposed along the travel path 100. Meanwhile, in principle, the equipment P installed in the transport facility 110 is supplied with a power from an electric cable other than the electric cable 2, which is wired from, for example, a distribution board. However, as the types or the number of devices included in the equipment P increases, the number of electric cables wired from the distribution board or the like increases, which tends to complicate the process of wiring work performed by an operator. Thus, when the noncontact power supply is also performed for the equipment P by using the power feeding lines 2a, the process of wiring work by the operator may be simplified. In this case, a power receiving apparatus 1 is necessary to receive a power from the power feeding lines 2a and supply the power to the target equipment P. Hereinafter, the power receiving apparatus 1 is described in detail.

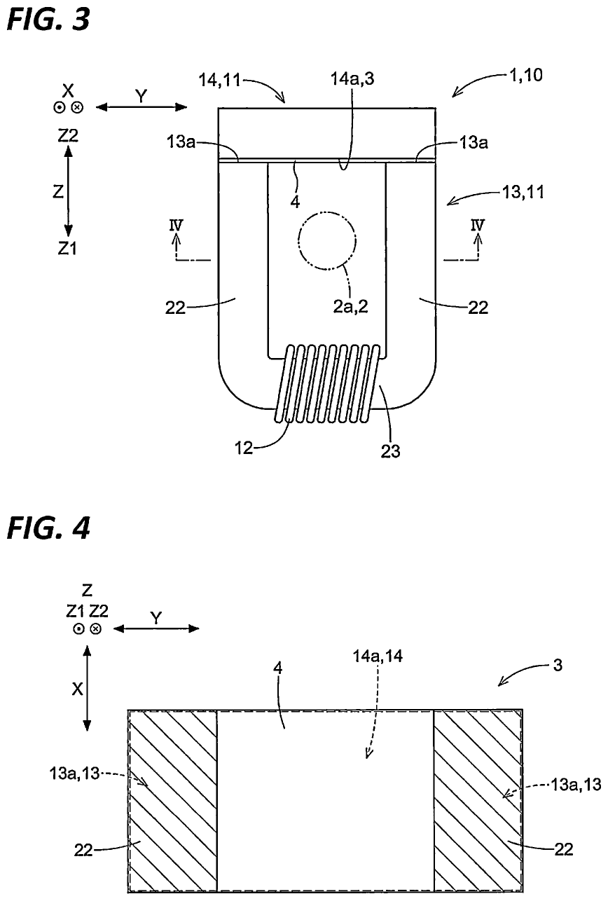

As illustrated in FIG. 1, the power receiving apparatus 1 receives a power from the electric cable 2, through which the AC current flows, in the noncontact manner, and supplies the power to the target equipment P. The power receiving apparatus 1 includes a coupler unit 10 that is installed in the state where the position thereof relative to the electric cable 2 is fixed. The coupler unit 10 is disposed to surround the single electric cable 2 (power feeding lines 2a) (FIG. 3). A conductor wire bundle obtained by tying a plurality of conductor wires may make up the single electric cable 2. In the present example, as illustrated in FIG. 1, the coupler unit 10 is attached to the folded portion 15 of the electric cable 2. Since the folded portion 15 is disposed at a position that does not interfere with the travel route of the moving body 50 (FIG. 1), the traveling of the moving body 50 is not interfered with the installation of the power receiving apparatus 1. In the example of FIG. 1, the folded portion 15 and the coupler unit 10 are illustrated in large size for the purpose of facilitating the understanding. For example, members for supporting the coupler unit 10 disposed to surround the power feeding lines 2a are appropriately selected according to the location where the equipment P is disposed or the form that supports the power feeding lines 2a at the folded portion 15. The coupler unit 10 may be fixed to, for example, the ceiling, or the lower or side surface of the travel rail R via the supporting members. Further, the coupler unit 10 may be disposed at the location where the AC power supply 5 and the power feeding lines 2a are connected to each other. Thus, the location where the coupler unit 10 is disposed is not limited to the folded portion 15. The target equipment P to which a power is supplied by the power receiving apparatus 1 may be a communication device (wireless access point) or a control device controlling the traveling of the mobile body 50, but is not limited thereto. The equipment P may be, for example, the processing apparatus described above or a semiconductor manufacturing apparatus.

As illustrated in FIG. 3, the coupler unit 10 includes a magnetic core 11 disposed to surround the electric cable 2, and a coil 12 wound around the magnetic core 11. The radio-frequency current flows in the electric cable 2 (power feeding lines 2a), and as a result, a magnetic field is generated around the power feeding lines 2a. Then, when the magnetic flux is collected in the magnetic core, the induced electromotive force is generated in the coil 12 (pickup coil). As a result, the induced current (AC current) flows in the coil 12. In the present example, ferrite is used as the magnetic material for the magnetic core 11, but the magnetic material is not limited thereto. Materials other than ferrite may be used as the magnetic material.

As illustrated in FIG. 3, the magnetic core 11 includes a first core portion 13 and a second core portion 14 that are divided into each other at a core division plane 3. The core division plane 3 is a virtual plane (boundary plane) that divides the magnetic core 11 into the first core portion 13 and the second core portion 14. In the present embodiment, the first core portion 13 and the second core portion 14 are arranged not to be in direct contact with each other. Specifically, a nonmagnetic body 4 to be described herein later is disposed between the first core portion 13 and the second core portion 14, so that the first core portion 13 and the second core portion 14 are not in contact with each other. In other words, the first core portion 13 and the second core portion 14 are connected to each other via the nonmagnetic body 4. The core division plane 3 may not necessarily be a flat plane as a whole, but may include a bent or curved portion.

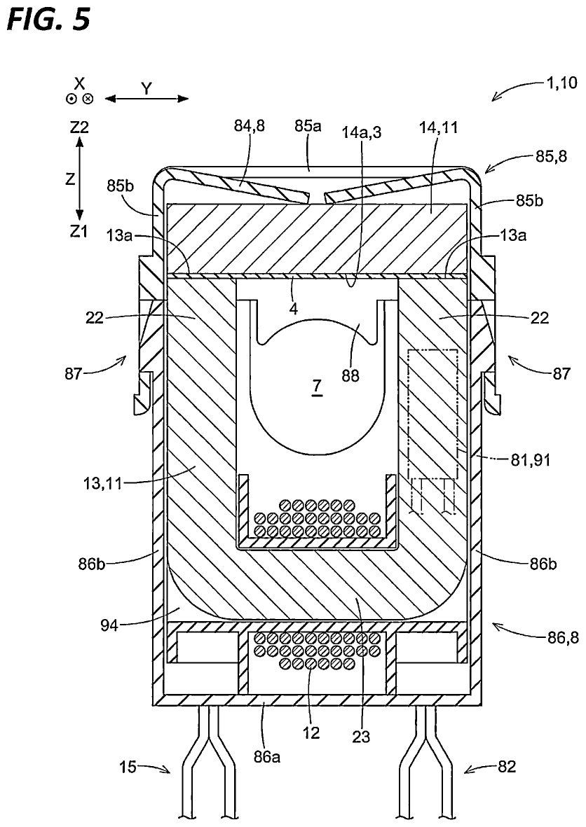

As illustrated in FIGS. 3 to 5, the second core portion 14 is a rod-shaped member. As illustrated in FIGS. 3 and 5, when the magnetic core 11 is positioned in a posture along the vertical direction Z, the second core portion 14 is a rod-shaped member elongated in the width direction Y. The second core portion 14 is disposed above the first core portion 13. As illustrated in FIGS. 3 to 5, the facing surface 14a of the second core portion 14, which is the surface disposed along the core division plane 3 and faces the side of the first core portion 13, is formed in a flat shape. In the present embodiment, the facing surface 14a is a plane along the electric cable direction X and the width direction Y, and is formed in a rectangular shape elongated in the width direction Y as a whole. In the illustrated example, the second core portion 14 has a rectangular parallelepiped shape. The entire surface of the second core portion 14 that faces the side of the first core portion 13 (one side of the vertical direction Z) is configured with the facing surface 14a. The regions of the facing surface 14a that face the first core portion 13 (specifically, the regions facing a pair of tip surfaces 13a to be described herein later) may be formed in the flat shape, and the other region of the facing surface 14a (region that does not face the first core portion 13) may not be formed in the flat shape. In the illustrated example, in order to facilitate the understanding of descriptions, the core division plane 3 is set as the facing surface 14a, but is not limited thereto. For example, a virtual plane set between the facing surface 14a and the tip surfaces 13a to be described herein later may be set as the core division plane 3.

As illustrated in FIGS. 3 and 5, the first core portion 13 is formed in a U shape surrounding the electric cable 2 when viewed from the electric cable direction X, and includes the pair of tip surfaces 13a arranged along the core division plane 3. The pair of tip surfaces 13a are divided in the width direction Y, and arranged in the same plane. The pair of tip surfaces 13a are connected to the facing surface 14a of the second core portion 14 via the nonmagnetic body 4. In the present embodiment, the first core portion 13 includes a pair of arm portions 22 of which respective end surfaces are the tip surfaces 13a, and a connection portion 23 that connects the opposite sides of the pair of arm portions 22 to the tip surfaces 13a. The pair of arm portions 22 are arranged to be separated from each other in the width direction Y. The tip surfaces 13a are formed as the surfaces of the arm portions 22 that face the second core portion 14 (specifically, the facing surface 14a). In the present example, each of the pair of arm portions 22 is formed in a rectangular parallelepiped shape elongated in the vertical direction Z, and thus, has a rectangular shape when viewed from the electric cable direction X. In the illustrated example, the outer edge of the end of each arm portion 22 on one side of the vertical direction Z (opposite to the tip surfaces 13a) is curved, but may not necessarily be curved. In the present embodiment, the “U shape” includes an angular U shape and a semicircular shape.

The connection portion 23 is a member connecting the ends of the pair of arm portions 22 on one side of the vertical direction Z (opposite to the tip surfaces 13a) to each other. The connection portion 23 is a rod-shaped member elongated in the width direction Y. In the illustrated example, the connection portion 23 is formed in a rectangular parallelepiped shape, but is not limited thereto. Here, the connection portion 23 is formed to be integrated with the pair of arm portions 22. Since the pair of arm portions 22 and the connection portion 23 are formed in this manner, the first core portion 13 is formed in the U shape as a whole. As illustrated in FIG. 3, the power feeding lines 2a are disposed between the pair of arm portions 22 while forming a gap from the pair of arm portions 22. The coil 12 is wound around the connection portion 23. In the present example, the coil 12 is wound around the entire connection portion 23, but may be wound around a part of the connection portion 23.

As illustrated in FIGS. 3 and 5, the facing surface 14a is disposed in parallel to the pair of tip surfaces 13a. As described above, the facing surface 14a is a plane along the electric cable direction X and the width direction Y. Each of the pair of tip surfaces 13a is also a plane along the electric cable direction X and the width direction Y. Thus, the facing surface 14a and the pair of tip surfaces 13a are arranged in parallel while facing each other in the vertical direction Z. Further, the pair of tip surfaces 13a are arranged to face the surfaces of both ends of the facing surface 14a in the width direction Y. In other words, when viewed from the vertical direction Z, the pair of tip surfaces 13a overlap with the surfaces of both ends of the facing surface 14a in the width direction Y, and do not overlap with the central region of the facing surface 14a in the width direction Y. Further, the facing surface 14a may not necessarily be parallel to the pair of tip surfaces 13a.

As illustrated in FIGS. 3 to 5, the nonmagnetic body 4 made of a nonmagnetic material is disposed along the facing surface 14a to cover the facing surface 14a, and sandwiched between the first core portion 13 and the second core portion 14. In the present embodiment, the nonmagnetic body 4 is disposed between the facing surface 14a and the pair of tip surfaces 13a that are disposed in parallel to each other. Here, the nonmagnetic body 4 is disposed to cover the entire facing surface 14a of the second core portion 14. Further, the nonmagnetic body 4 is in contact with the entire facing surface 14a of the second core portion 14. The nonmagnetic body 4 is formed in the same size and shape as those of the facing surface 14a. Meanwhile, the nonmagnetic body 4 is in contact with the pair of tip surfaces 13a at both ends thereof in the width direction Y. That is, when viewed from the vertical direction Z, the nonmagnetic body 4 overlaps with the entire facing surface 14a and overlaps with the pair of tip surfaces 13a at both ends thereof in the width direction Y (e.g., FIG. 4). In the present embodiment, as illustrated in FIGS. 3 to 5, the nonmagnetic body 4 is formed in a single plate or sheet shape. Here, both the “plate shape” and the “sheet shape” are flat shapes. However, for example, based on whether the bending rigidity is high or low, the “plate shape” may be defined as having the relatively high bending rigidity, and the “sheet shape” may be defined as having the relatively low bending rigidity. Further, based on the presence or absence of flexibility, the “plate shape” may be defined as having the flexibility, and the “sheet shape” may be defined as having no flexibility. Further, based on whether the thickness is large or small, the “plate shape” may be defined as having the relatively large thickness, and the “sheet shape” may be defined as having the relatively small thickness. Further, the “single” plate or sheet is not limited to a plate or sheet formed of one layer, but may be a plate or sheet formed by integrating multiple layers through, for example, adhesion or fusion. In the present example, the nonmagnetic body 4 is a film formed of a resin material, and is formed in the single sheet shape. The nonmagnetic body 4 may be a plate-shaped member, and in this case, is formed in the single plate shape. The nonmagnetic body 4 made of the nonmagnetic material has a function to make it difficult for the magnetic flux to pass through the magnetic core 11. That is, when the nonmagnetic body 4 is provided, the magnetic resistance of the entire magnetic core 11 may be increased. The nonmagnetic body 4 may be formed to be larger or smaller than the facing surface 14a. In the illustrated example, the nonmagnetic body 4 adheres to the facing surface 14a.

In the example of FIG. 3, in the state where the coupler unit 10 is disposed on the power feeding lines 2a, the power feeding lines 2a are disposed to be surrounded by the first core portion 13, the nonmagnetic body 4, and the coil 12. Further, the power feeding lines 2a are disposed not to be in contact with any of the first core portion 13, the nonmagnetic body 4, and the coil 12. The power feeding lines 2a are also disposed not to be in contact with the second core portion 14.

As illustrated in FIG. 5, in the present embodiment, a detection unit 81 of a temperature sensor 91 is disposed in contact with at least one of the pair of arm portions 22. In the present example, the detection unit 81 is disposed on only one arm portion of the pair of arm portions 22. Further, the detection unit 81 is disposed to be in contact with the surface of the arm portion 22.

As illustrated in FIG. 5, in the present embodiment, the power receiving apparatus 1 includes an insertion through hole 7 through which the electric cable 2 is inserted, and a housing 8 that accommodates the first core portion 13 and the second core portion 14. The housing 8 accommodates the coupler unit 10. Specifically, the housing 8 accommodates the coil 12, the nonmagnetic body 4, and the detection unit 81, in addition to the first core portion 13 and the second core portion 14. The first core portion 13 and the second core portion 14 are supported in the housing 8.

In the present embodiment, the housing 8 includes a first housing portion 86, a second housing portion 85, and a fitting mechanism 87 that are removable from each other. The first housing portion 86 and the second housing portion 85 have a box shape. In the present example, the first housing portion 86 is disposed on the first side of vertical direction Z1 with respect to the second housing portion 85. The first housing portion 86 accommodates the first core portion 13, and the second housing portion 85 accommodates the second core portion 14. In the illustrated example, the opening of the first housing portion 86 is covered with the second housing portion 85, and the first housing portion 86 and the second housing portion 85 are fitted to each other by the fitting mechanism 87 to be fixed to each other without being separated from each other. As a result, the pair of tip surfaces 13a of the first core portion 13 are in contact with the nonmagnetic body 4 adhering to the facing surface 14a. When the fitting by the fitting mechanism 87 is released, the first housing portion 86 and the second housing portion 85 may be separated from each other. Here, the first core portion 13 is accommodated in advance in the first housing portion 86, and the second core portion 14 is also accommodated in advance in the second housing portion 85. Further, the first housing portion 86 and the second housing portion 85 may be connected to each other by a hinge, so that the second housing portion 85 may be opened and closed with respect to the opening of the first housing portion 86. The posture in which the housing 8 is positioned may be appropriately changed according to the posture of the disposed power feeding lines 2a.

In the present example, as illustrated in FIG. 5, the second housing portion 85 accommodates the second core portion 14 and the nonmagnetic body 4 as a whole. In the illustrated example, the second housing portion 85 includes an upper-side bottom portion 85a and a second side wall 85b extending from the outer edge of the upper-side bottom portion 85a toward the first side of vertical direction Z1. The tip end of the second side wall 85b is positioned further extending to the first side of vertical direction from the second core portion 14 and the nonmagnetic body 4. The first housing portion 86 accommodates the first core portion 13, the coil 12, and the detection unit 81. The first housing portion 86 includes a lower-side bottom portion 86a and a first side wall 86b extending from the outer edge of the lower-side bottom portion 86a to the second side of vertical direction Z2. The tip end of the first side wall 86b is positioned further extending to the first side of vertical direction Z1 from the pair of tip surfaces 13a of the first core portion 13. In the present example, the insertion through hole 7 is formed to penetrate the first side wall 86b in the electric cable direction X (here, in the second side of vertical direction Z2). The insertion through hole 7 is formed between the pair of arm portions 22, when viewed from the electric cable direction X.

The insertion through hole 7 is curved on the first side of vertical direction Z1 rather than the central portion thereof, to correspond to the cross-sectional shape of the power feeding lines 2a. In the illustrated example, a guide unit 88 is formed in the second housing portion 85. The guide unit 88 is disposed to protrude toward the first side of vertical direction Z1 with respect to the second side wall 85b. Further, the guide unit 88 has a curved shape to correspond to the cross-sectional shape of the power feeding lines 2a. In the state where the power feeding lines 2a are inserted through the insertion through hole 7, and the first housing portion 86 and the second housing portion 85 are fitted to each other, the power feeding lines 2a are disposed to be surrounded by the first side wall 86b and the guide unit 88.

In the present example, as illustrated in FIG. 5, the housing 8 includes a pressing unit 84 that presses either one of the first core portion 13 and the second core portion 14 toward the other. In the present example, the pressing unit 84 presses the second core portion 14 toward the first side of vertical direction Z1 (the side of the first core portion 13). In the present example, the pressing unit 84 is provided in the second housing portion 85. In the illustrated example, the pressing unit 84 is provided on the upper-side bottom portion 85a. The pressing unit 84 is configured with a pair of plate-shaped members extending inwardly in the width direction Y from a portion of the outer edge of the upper-side bottom portion 85a (two locations facing each other in the width direction Y in the present example), and each plate-shaped member is positioned in a posture inclined toward the first side of vertical direction Z1 as extending inwardly in the width direction Y. The tip ends of the pair of plate-shaped members facing each other press the second core portion 14 from the second side of vertical direction Z2. In the present example, the pressing unit 84 is a plate-shaped resin member integrated with the second housing portion 85. However, the pressing unit 84 may be an elastic member (e.g., a spring) provided separately from the second housing portion 85.

In the example of FIG. 5, the coil 12 is wound around the connection portion 23 via a bobbin 94. Here, the bobbin 94 is supported in the first housing portion 86. In the state where the first housing portion 86 and the second housing portion 85 are fitted to each other, the second core portion 14 is pressed toward the first core portion 13 due to the constant pressing force by the pressing unit 84. As a result, it is possible to avoid the circumstance that the tip surfaces 13a is separated from the facing surface 14a (or the nonmagnetic body 4). Therefore, it is possible to easily optimize the distance between the second core portion 14 and the first core portion 13 that sandwich the nonmagnetic body 4 therebetween.

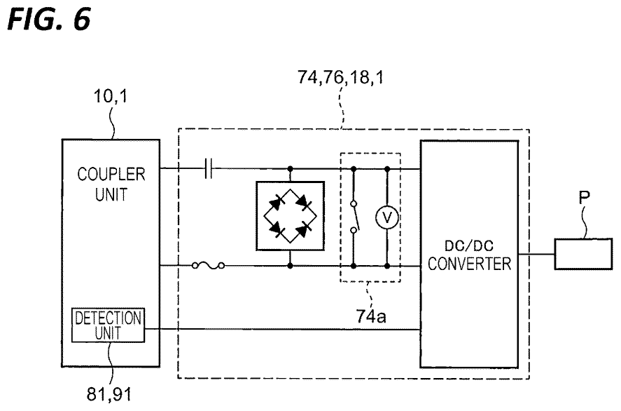

In the present embodiment, as illustrated in FIGS. 1 and 6, the power receiving apparatus 1 further includes a power conversion unit 18 that converts the AC power output from the coupler unit 10 into the DC power. As illustrated in FIG. 6, the power conversion unit 18 includes an overvoltage protection circuit 74 that cuts off the circuit when the voltage at both ends of the coil 12 exceeds a predetermined threshold value, and an overcurrent protection circuit 76 that cuts off the circuit when the current flowing in the coil 12 exceeds a predetermined threshold value. FIG. 6 schematically illustrates the overvoltage protection circuit 74 and the overcurrent protection circuit 76 in the power conversion unit 18. Here, the power conversion unit 18 further includes a DC/DC converter. The overvoltage protection circuit 74 includes an overvoltage detection unit 74a. When the voltage at both ends of the coil 12 exceeds the predetermined threshold value, the overvoltage detection unit 74a is short-circuited. Then, the power receiving apparatus 1 (coupler unit 10) and the capacitor enter the resonance state, an overcurrent flows to the power conversion unit 18, and the fuse is melted and disconnected. The fuse is also melted and disconnected when the current flowing in the coil 12 exceeds the predetermined threshold value, for example, when an overcurrent flows. As a result, the circuit of the power conversion unit 18 is cut off. In the present example, when a value exceeding the predetermined threshold value is detected by the detection unit 81 of the temperature sensor 91 in the arm portion 22, the output of the DC/DC converter to the equipment P is stopped, and the current of the coil 12 is considered the cause of overheating and is suppressed. In the present example, the control unit 9 may perform the protection control for the power receiving apparatus 1.

Next, other embodiments of the power receiving apparatus are described.

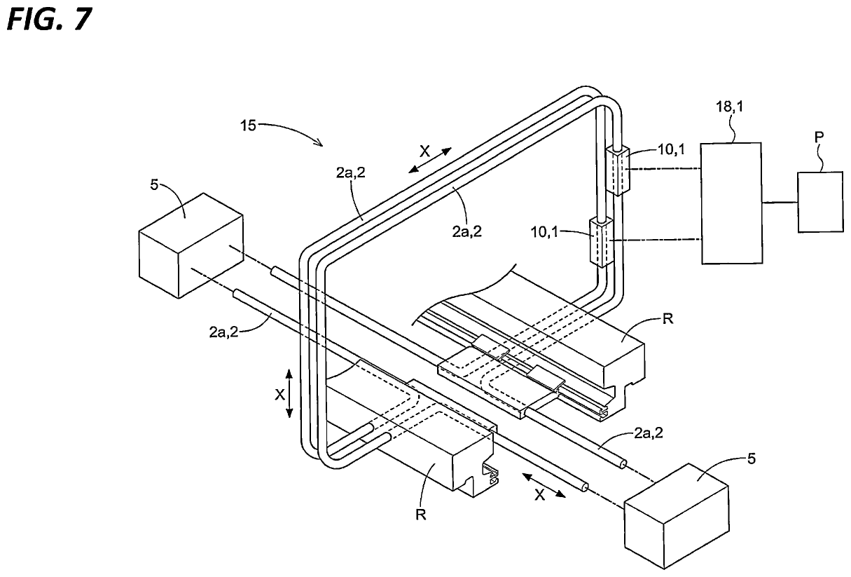

(1) In the embodiment above, the single AC power supply 5 is provided in the transport facility 110, and the power receiving apparatus 1 is supplied with a power from the electric cable 2 connected to the AC power supply 5. However, the present disclosure is not limited thereto, and for example, a plurality of AC power supplies 5 to which the electric cable 2 is connected may be provided in the transport facility 110. In this case, the power receiving apparatus 1 may be connected to the plurality of AC power supplies 5 via the electric cable 2, and even when one of the AC power supplies 5 stops unexpectedly, a power may be supplied to the equipment P by using another AC power supply 5. FIG. 7 illustrates this example. In the illustrated example, the transport facility 110 includes at least two AC power supplies 5. Then, different power feeding lines 2a are connected to the AC power supplies 5, respectively. In the folded portion 15, each of the two power feeding lines 2a is formed in a loop shape extending vertically to surround the travel route of the moving body 50. As a result, the folded portion 15 does not interfere with the moving body 50 during the traveling. Further, coupler units 10 are attached to the loop-shaped portions of the power feeding lines 2a, respectively. The power conversion unit 18 and the equipment P are connected in common to each coupler unit. Thus, even when one of the two AC power supplies 5 stops, the power receiving apparatus 1 may be supplied with a power using the other AC power supply 5, so that the power receiving apparatus 1 may continue to supply a power to the equipment P.

(2) In the embodiment above, when viewed from the electric cable direction X, the first core portion 13 is formed in the U shape surrounding the electric cable 2. However, the present disclosure is not limited thereto. The first core portion 13 may have a shape other than the U shape. For example, the first core portion 13 may be formed in an E shape. In this case, three tip surfaces 13a may be formed on three arm portions 22, and each of the three tip surfaces 13a may be connected to the facing surface 14a via the nonmagnetic body 4. As a result, two electric cables 2 may be each disposed between adjacent arm portions 22.

(3) In the embodiment above, the nonmagnetic body 4 is formed in the single plate or sheet shape. However, the present disclosure is not limited thereto. The nonmagnetic body 4 may be formed in the shape of a plurality of plates or sheets. Further, in the embodiment above, the nonmagnetic body 4 is disposed to cover the entire facing surface 14a of the second core portion 14. However, the nonmagnetic body 4 may be disposed to cover only a portion of the facing surface 14a. For example, in FIGS. 3 to 5, a pair of nonmagnetic bodies 4 may be disposed in the regions of the facing surface 14a that face the pair of tip surfaces 13a, respectively, and may not be disposed in the region of the facing surface 14a that does not face the pair of tip surfaces 13a. Further, the nonmagnetic body 4 may be formed in the shape of a plurality of plates or sheets with a plurality of holes penetrating the plates or sheets in the thickness direction, and cover only a portion of the facing surface 14a. In this case, in the regions where the holes are formed, voids are formed between the facing surface 14a and the tip surfaces 13a.

(4) In the embodiment above, the coil 12 is wound around the connection portion 23. However, the present disclosure is not limited thereto. The coil 12 may be wound around, for example, the arm portions 22. In the embodiment above, the detection unit 81 of the temperature sensor 91 is disposed in contact with the arm portion 22, and when a value exceeding the predetermined threshold value is detected by the detection unit 81, the output of the DC/DC converter to the equipment P is stopped. However, the present disclosure is not limited thereto. For example, an overheat protection circuit may be provided in the power conversion unit 18, in order to prevent current from flowing in the coil 12 when the detection unit 81 detects an abnormal overheat of the arm portions 22. Further, the temperature sensor 91 may be configured to simply transmit the surface temperature of the arm portions 22 detected by the detection unit 81 to the control unit 9 as detection information.

(5) In the embodiment above, the housing 8 includes the pressing unit 84 that presses either one of the first core portion 13 and the second core portion 14 toward the other. However, the present disclosure is not limited thereto. The pressing unit 84 may be configured to press each of the first core portion 13 and the second core portion 14, such that the first core portion 13 and the second core portion 14 become close to each other.

(6) The configuration described in each of the embodiments described above may be applied in combination with the configurations described in the other embodiments, as long as no contradiction arises. Further, the embodiments described herein are examples in all aspects, and may be modified appropriately within the scope that does not depart from the gist of the present disclosure.

### <Summary of Foregoing Embodiments>

Below is the summary of the power receiving apparatus that has been described.

The present disclosure provides a power receiving apparatus for receiving power in a noncontact manner from an electric cable through which an AC current flows, and supplying the power to a target equipment. The power receiving apparatus includes: a coupler provided in a state where a position thereof relative to the electric cable is fixed. The coupler includes a magnetic core disposed to surround the electric cable, and a coil wound around the magnetic core. The magnetic core includes a first core portion and a second core portion that are divided from each other by a core division plane. In the second core portion, a facing surface is formed in a flat shape to be disposed along the core division plane while facing the first core portion. A nonmagnetic body made of a nonmagnetic material is disposed along the facing surface to cover the facing surface, and sandwiched between the first core portion and the second core portion.

According to the configuration above, the magnetic core is divided into the first core portion and the second core portion, and the nonmagnetic body is disposed to cover the facing surface of the second core portion and sandwiched between the first core portion and the second core portion, so that the first core portion and the second core portion are not continuously connected. As a result, the magnetic resistance in the magnetic core may be increased, which may make it difficult for the magnetic core to saturate magnetically. Therefore, it is possible to suppress, for example, the occurrence of a situation that the inductance of the coil drops rapidly due to the magnetic saturation of the magnetic body, and thus, an overcurrent flows in the coil, which may easily stabilize the current drawn from the coil.

Further, according to the present configuration, the magnitude of magnetic resistance (magnitude of magnetic permeability) of the magnetic core may be adjusted by adjusting the thickness of the nonmagnetic material in advance, so that the non-uniformity of the characteristics of the power receiving apparatus may easily be reduced.

Further, according to the present configuration, the facing surface of the second core portion is formed in a flat shape, and the nonmagnetic body made of a nonmagnetic material is disposed along the facing surface to cover the facing surface, so that the shape of the second core portion may easily be simplified, and the shape of the nonmagnetic body may easily be made flat. Therefore, the shape or structure of the nonmagnetic body may easily be simplified, and the work for attaching the nonmagnetic body may easily be simplified.

According to the present configuration, a power may be stably supplied to the target equipment.

Here, a direction along the electric cable may be defined as an electric cable direction. Then, when viewed from the electric cable direction, the first core portion may be formed in a U shape surrounding the electric cable, and include a pair of tip surfaces disposed along the core division plane, and the facing surface may be disposed in parallel to the pair of tip surfaces. According to the configuration above, the shape of the first core portion may be simplified. Further, since the facing surface is formed in the flat shape, and the pair of tip surfaces are arranged in parallel, the shapes of the pair of tip surfaces of the first core portion, the facing surface of the second core portion, and the nonmagnetic body disposed therebetween may easily be simplified. Further, the nonmagnetic body may be formed in the single plate or sheet shape.

According to the configuration above, the number of components of the power receiving apparatus may be reduced, as compared to the case where the nonmagnetic body is divided into a plurality of sheets.

The first core portion may include a pair of arm portions of which end surfaces are the tip surfaces, respectively, and a connection portion that connects opposite sides of the pair of arm portions to the tip surfaces to each other, the coil may be wound around the connection portion, and a detector of a temperature sensor may be disposed to be in contact with at least one of the pair of arm portions.

According to the configuration above, the coil is wound around the connection portion, and the detector of the temperature sensor is disposed in contact with the arm portion. Thus, since each of the coil and the detector of the temperature sensor may be attached using the shape of the first core portion, the coil and the temperature sensor may easily be attached, and the power receiving apparatus may easily be downsized.

The power receiving apparatus may further include: a housing including an insertion through hole through which the electric cable is inserted, and accommodating the first core portion and the second core portion, and the housing may include a presser that presses either one of the first core portion and the second core portion toward a remaining one.

According to the configuration above, the first core portion and the second core portion are accommodated in the housing, so that the first and second core portions may be appropriately protected. Further, the housing includes the pressing unit, so that the distance between the second core portion and the first core portion that sandwich the nonmagnetic body therebetween may easily be optimized.

The power receiving apparatus according to the present disclosure may be any power receiving apparatus, which achieves at least one of the foregoing effects.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A power receiving apparatus comprising:
a coupler provided in a state where a position thereof relative to an electric cable through which an AC current flows is fixed, the power receiving apparatus receiving power from the electric cable in a noncontact manner and supplying the power to a target equipment,
wherein the coupler includes a magnetic core disposed to surround the electric cable, and a coil wound around the magnetic core,
the magnetic core includes a first core portion and a second core portion that are divided from each other by a core division plane,
in the second core portion, a facing surface is formed in a flat shape to be disposed along the core division plane while facing the first core portion, and
a nonmagnetic body made of a nonmagnetic material is disposed along the facing surface to cover the facing surface, and sandwiched between the first core portion and the second core portion.

2. The power receiving apparatus according to claim 1, wherein a direction along the electric cable is defined as an electric cable direction,
the first core portion is formed in a U shape surrounding the electric cable when viewed from the electric cable direction, and includes a pair of tip surfaces disposed along the core division plane, and
the facing surface is disposed in parallel to the pair of tip surfaces.

3. The power receiving apparatus according to claim 2, wherein the nonmagnetic body is formed in a single plate or sheet shape.

4. The power receiving apparatus according to claim 2, wherein the first core portion includes a pair of arm portions of which end surfaces are the tip surfaces, respectively, and a connection portion that connects opposite sides of the pair of arm portions to the tip surfaces to each other,
the coil is wound around the connection portion, and
a detector of a temperature sensor is disposed to be in contact with at least one of the pair of arm portions.

5. The power receiving apparatus according to claim 1, further comprising:
a housing including an insertion through-hole through which the electric cable is inserted, and accommodating the first core portion and the second core portion,
wherein the housing includes a presser that presses either one of the first core portion and the second core portion toward a remaining one.
